(19) United States
(12) Patent Application Publication
(10) Pub. No.: US 2005/0172501 A1
(43) Pub. Date: Aug. 11, 2005

(54) Trimmer line and method of manufacture

(75) Inventor: John R. Fogle, Carefree, AZ (US)

Correspondence Address: LaValle D. Ptak;Ste. B, 28435 N. 42nd St., Cave Creek, AZ, 85331, US

(73) Assignee: Robert L. Phillips (50%)

(21) Appl. No.: 10/777,291

(22) Filed: Feb. 10, 2004

(51) Int. Cl. A01D 34/00

(52) U.S. Cl. 30/347; 30/276

(57) ABSTRACT

Elongated string trimmer line is configured with a cross section throughout its length having a thickness which is less than the width thereof, and which includes top and bottom surfaces at least a portion of which are located in parallel planes. The line may be made by passing a blank of high molecular weight orientable plastic through opposing calendering rollers, which impart bi-axial orientation to the molecular structure of the finished line.

### BACKGROUND

This invention relates to the field of string trimmer lines used for rotary string trimmers, and to a method of manufacturing such line.

### BRIEF DESCRIPTION OF THE DRAWINGS

FIG. 1 is a perspective view illustrating a string trimmer machine of the type with which the line of the present invention may be used;

FIG. 2 is a top perspective diagrammatic view of a rotating string trimmer head of the type with which line of the invention may be used;

FIG. 3 is a partial perspective view of an embodiment of the invention;

FIG. 4 is a partial perspective view of an embodiment of the invention;

FIG. 5 is a partial perspective view of an embodiment of the invention;

FIG. 6 is a partial perspective view of an embodiment of the invention;

FIG. 7 is a partial perspective view of an embodiment of the invention;

FIG. 8 is a partial perspective view of an embodiment of the invention;

FIG. 9 is a partial perspective view of an embodiment of the invention;

FIG. 10 is a partial perspective view of an embodiment of the invention;

FIG. 11 is a top view of the embodiment shown in FIG. 10;

FIG. 12 is a partial perspective view of an embodiment of the invention;

FIG. 13 is a top view of the embodiment shown in FIG. 12;

FIG. 14 is a partial perspective view of an embodiment of the invention;

FIG. 15 is a partial perspective view of an embodiment of the invention;

FIG. 16 is a cut-away perspective view of a portion of a head of a string trimmer machine with which the various embodiments of the invention may be used;

FIG. 17 illustrates an operating feature of the head of FIG. 16, using embodiments of the invention;

FIG. 18 is a diagrammatic representation of a prior art method of manufacturing string trimmer line;

FIGS. 19 and 20 illustrate features of prior art string trimmer lines;

FIGS. 21 and 22 diagrammatically illustrate features of an embodiment of the invention;

FIG. 23 is a top view illustrating features of a method of an embodiment of the invention;

FIG. 24 is an end view of a portion of the embodiment shown in FIG. 23;

FIG. 25 is a diagrammatic illustration of a method of an embodiment of the invention;

FIG. 26 is a diagrammatic illustration of a method of an embodiment of the invention; and

FIG. 27 is a top view illustrating a method of an embodiment of the invention.

### DETAILED DESCRIPTION

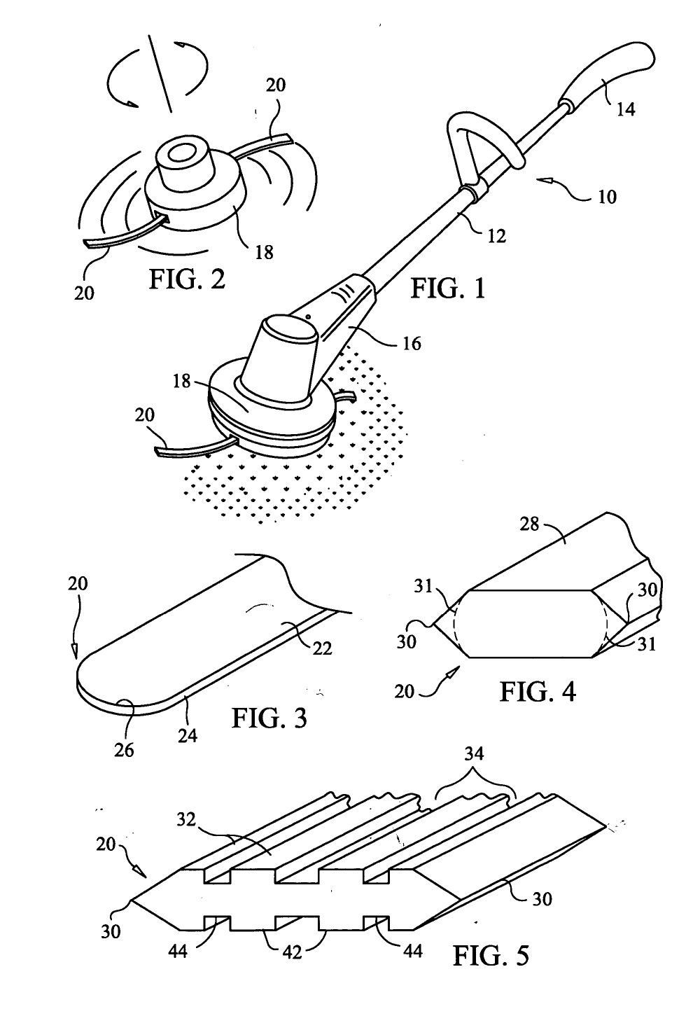

Reference now should be made to the drawings in which the same reference numbers are used throughout the different figures to designate the same or similar components. FIGS. 1 and 2 depict a general type of string trimmer machine, with which the various embodiments of the invention are to be used. Such machines 10 typically include an elongated tubular portion 12 having an upper handle 14 and a lower motor 16. The motor may be either an electric motor or a gas powered motor.

The machine 10 rotates an operating head 18, out of which one or more lengths of string trimmer line 20 extend. The machine which is shown in FIG. 1 has a configuration generally used for electric string trimmer machines. When a gasoline powered string trimmer machine is used, the motor typically is located at the upper end 14 of the portion 12, and operates through a rotating shaft located within the portion 12 to rotate the head 18. In either event, the operation, so far as the trimmer string 20 is concerned, is the same. This operation generally is represented in FIG. 2 where the head 18 is rotated continuously in a circular direction (as shown by the arrows) to spin extended lengths of trimmer string 20 for cutting vegetation.

Typically, the trimmer string 20 is made of extruded monofilament plastic or nylon line. Generally, this line is of a circular cross section, with typical diameters ranging from 0.050″ to 0.155″. The smaller diameter line generally is employed with electric string trimmer machines, since electric machines lack the power of gas powered machines; and small diameter line presents less drag than larger diameter lines. The rotational speeds of the heads used in the trimmers of the type generally shown in FIG. 1 typically are between 2,000 and 20,000 RPM's.

Replacement of worn line periodically must be effected during operation of the trimmer. This may be accomplished by means of “bump-and-feed” mechanisms which supply lengths of line from a reservoir or spool within the machine, or in the case of machines using fixed lengths of trimmer line, replacing a spent length of line with a new one.

It has been found that the air resistance or drag which is subjected by the line on the motor and the rest of the drive mechanism of the machine is, in large part, determined by the profile of the line which strikes the air at the high rotating speeds mentioned above. Thus, large diameter lines present a greater amount of drag than small diameter lines. Square or triangular cross section lines of comparable mass to round cross section lines present more drag than round lines. For electric string trimmer machines in particular, the amount of drag has a noticeable significant effect on the operation of the motor; so that relatively small diameter lines generally are employed with such electric machines.

The ability of the line, however, to cut heavier vegetation, in an efficient and effective manner, also depends, to a fairly significant extent, upon the mass of the line which strikes the vegetation. Obviously, a small diameter line has much less mass per unit of given length than a large diameter line. As a result, most commercial string trimmer machines employ relatively powerful gasoline-driven motors with larger diameter lines.

In order to maintain the drag as low as possible and to increase the mass-per-unit of given length of the line, various embodiments or configurations of line, which are illustrated by way of example in FIGS. 3 through 14, have been devised. The line configurations shown in these various figures typically may be employed in string trimmer machines using fixed length line segments, which are replaced when the previous line segment has been used up or depleted. The various embodiments which are illustrated in FIGS. 3 through 15, however, also may be adapted for continuous feed machines in which the exit slots through the head of the machine and the internal machine mechanism are adapted to employ the various cross-sectional configurations which are illustrated.

In all of FIGS. 3 through 15 short lengths of a portion of an embodiment of line of the invention are illustrated. The line is in the form of an elongated filament, typically made of high molecular weight orientable thermoplastic material, such as nylon 6 or other nylon copolymers. Typical molecular weights, as measured by relative viscosity (in formic acid) are above about 60. The filament may be considered to have an elongated central axis (or centerline) which extends its length, with the line extending on opposite sides symmetrically of the centerline. The cross section of the filament perpendicular to the central axis or centerline is selected to have a thickness which is less than its width.

The line filament has top and bottom surfaces, at least a portion of which are located in parallel planes. This is illustrated in FIGS. 3 and 4 in a basic form, particularly useful with bi-axially oriented material. The elongated line filament 20 of both of these figures has an upper surface (22 in FIG. 3 and 28 in FIG. 4), in a plane spaced a short distance from and parallel to the plane of a lower surface (not numbered in either of these figures). The cross-sectional configuration of the line of FIGS. 3 and 4 is essentially rectangular; and the end 26 is rounded or curved to improve the operating characteristics of the line when fixed or cut lengths of the line 20 are used in a typical machine, as shown in FIGS. 1 and 2.

As is readily apparent from an examination of both FIGS. 3 and 4, the vertical thickness through the line filament is less than the width of the line filament, typically on the order of a width which is three to eight times greater than the thickness or vertical height of the line filament. The flat or generally flat configuration of the trimmer line allows the line to move in a manner where the line thickness or leading edge is the primary factor in determining the drag of the line on the motor when the line is being rotated. When a line having a thickness of the diameter of a a standard circular cross section line is employed in a given machine, but having the overall shape characteristics illustrated in FIGS. 3 and 4, it is readily apparent that the mass-per-unit length of the line is several times as much as the corresponding mass of a standard circular cross-sectional configuration line. As a result, even though the thickness or edge of the line which strikes the air (and the vegetation in its path) is the same, or substantially the same as a corresponding standard diameter line, the mass, and therefore the cutting power of the line, is significantly increased by employing the shapes shown in the various figures, with FIGS. 3 and 4 discussed here being representative. Current draw for an electric trimmer machine using line filaments of different aspect ratios compared to round line with a diameter comparable to the thickness of the flat line filaments is shown below in Table 1:

TABLE 1
MOTOR CURRENT DRAW, IN AMPS (5.5 AMP MOTOR)

| | | | | Line length in inches | | | | | |
|---|---|---|---|---|---|---|---|---|---|
| | | | | 3.0 | 3.5 | 4.0 | 4.5 | 5.0 | |
| | | | | Cut path in inches | | | | | |
| | | | | 10.5 | 11.5 | 12.5 | 13.5 | 14.5 | |
| | | | ASPECT | | | | | | ROUND EQUIVALENT |
| ITEM | SHAPE | DIMENSIONS | RATIO | CURRENT DRAW (amps) | | | | | (In mils) |
| 1 | flat | .079″ × .260″ | 3.3 | 3.95 | 4.08 | 4.18 | 4.49 | 4.83 | 139.2 mils |
| 2 | flat | .082″ × .250″ | 3.0 | 3.91 | 4.02 | 4.15 | 4.26 | 4.59 | 145.4 mils |
| 3 | flat | .080″ × .198″ | 2.5 | 3.75 | 3.85 | 3.94 | 4.16 | 4.42 | 122.8 mils |
| 4 | flat | .082″ × .350″ | 4.3 | 3.84 | 3.93 | 4.14 | 4.42 | 4.83 | 176.2 mils |
| 5 | round | .080″ × .080″ | 1.0 | 3.96 | 4.08 | 4.25 | 4.50 | 4.91 | 80.0 mils |

From Table 1 above it may be seen that the improvement in cutting energy (the mass of the line striking the object at any given rotational speed) can be estimated as a comparison of the square of the diameter of a round line (or circular cross-sectional line) mass ratio, with the equivalent mass provided by the various aspect ratios of the generally flat line of the type shown in FIGS. 3 and 4, assuming that the tip speed (RPM) is constant at comparable current draws for the electric motor of the trimmer machines utilized in conducting the tests. This machine, for the tests of Table 1, was a 5.5 AMP Craftsman® electric straight shaft trimmer. The cutting energy comparison is shown below in Table 2:

TABLE 2

| | | | ASPECT | EQUIV. ROUND | | |
|---|---|---|---|---|---|---|
| ITEM | SHAPE | DIMENSIONS | RATIO | IN MILS | COMP. SIZE | MASS RATIO |
| 1 | flat | 0.079″ × 0.260″ | 3.3 | 139.2 | 193.77 × 10⁻⁴ | 3.03 |
| 2 | flat | 0.080″ × 0.198″ | 2.5 | 122.8 | 150.80 × 10⁻⁴ | 2.36 |
| 3 | flat | 0.082″ × 0.250″ | 3.0 | 145.4 | 211.41 × 10⁻⁴ | 3.30 |
| 4 | flat | 0.082″ × 0.350″ | 4.3 | 176.2 | 310.46 × 10⁻⁴ | 4.85 |
| 5 | round | 0.080 × 080″ | 1 | 80.0 | 64.00 × 10⁻⁴ | 1.0 |

In FIG. 4, it also is illustrated that the edges of the line which strike the vegetation and which move through the air may be curved or bulged to improve the reduced drag operation, such as shown in dotted lines 31, or they may be tapered outwardly to a point in a plane substantially midway between the planes of the upper and lower surfaces to form a sharp cutting edge 30 extending the full length of the line.

FIG. 5 illustrates an embodiment which is a variation of the one shown in FIG. 4, in which the upper plane 32 and the lower plane 42 of the upper and lower surfaces of the line are interrupted by longitudinal rectangular grooves 34 on the top and 44 on the bottom extending the length of the line to form thinner areas and thicker areas of cross section transversely across the like, as illustrated clearly in FIG. 5.

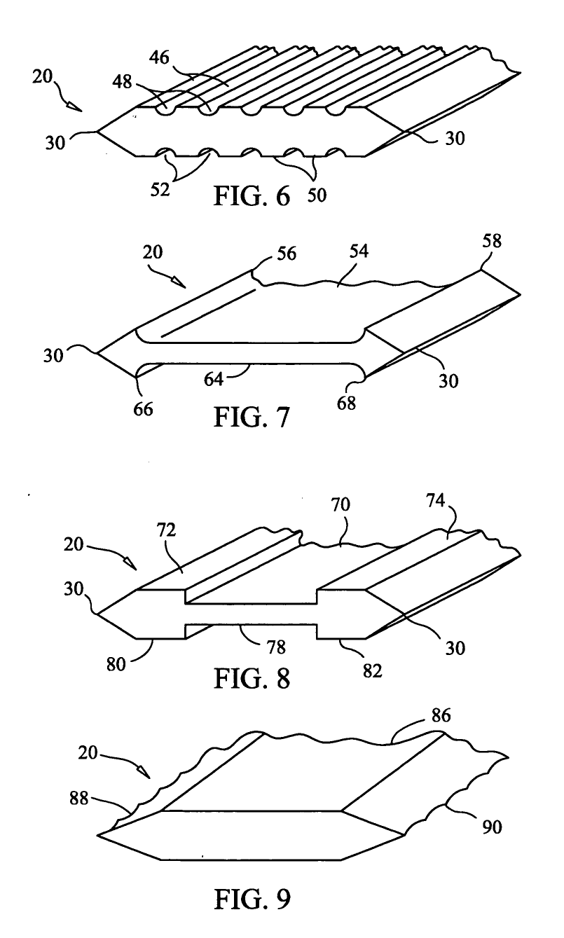

FIG. 6 is a variation of the line shown in FIG. 5, in which the flat upper surfaces 46 and flat lower surfaces 50 in the parallel planes forming the top and bottom of the line are interrupted by a plurality of rounded or convex indentations 48 on the top and 52 on the bottom, as clearly illustrated in FIG. 6.

FIG. 7 is yet another variation of the line illustrating an embodiment in which the upper and lower parallel planar surfaces 54 and 64 terminate at the outer edges in a thicker arrow shaped configuration, curved upwardly to edges 56 and 58 on the top of the line and curved downwardly to edges 66 and 68 on the bottom 64 of the line to form arrow-like edges terminating in the elongated cutting edges 30.

FIG. 8 is a variation of the line shown in FIG. 7, but where inner upper and lower planar surfaces 70 and 78 each are terminated in raised or stepped planar surfaces 72 and 74 for the top of the line and 80 and 82 for the bottom of the line, again to terminate in the sharp edges 30 discussed previously in conjunction with others of the embodiments.

It should be noted that the shapes of the various embodiments of line shown in FIGS. 3 through 8 all may be formed from continuous extrusions. To obtain bi-axial orientation, these extruded shapes or fixed length blanks may be reformed by calendering rollers, or other suitable means. FIG. 9 is a variation of the line shown in FIG. 4, but one in which the edge of the line having a flat top surface 86 has been replaced by opposing scalloped or saw-toothed edges 88 and 90.

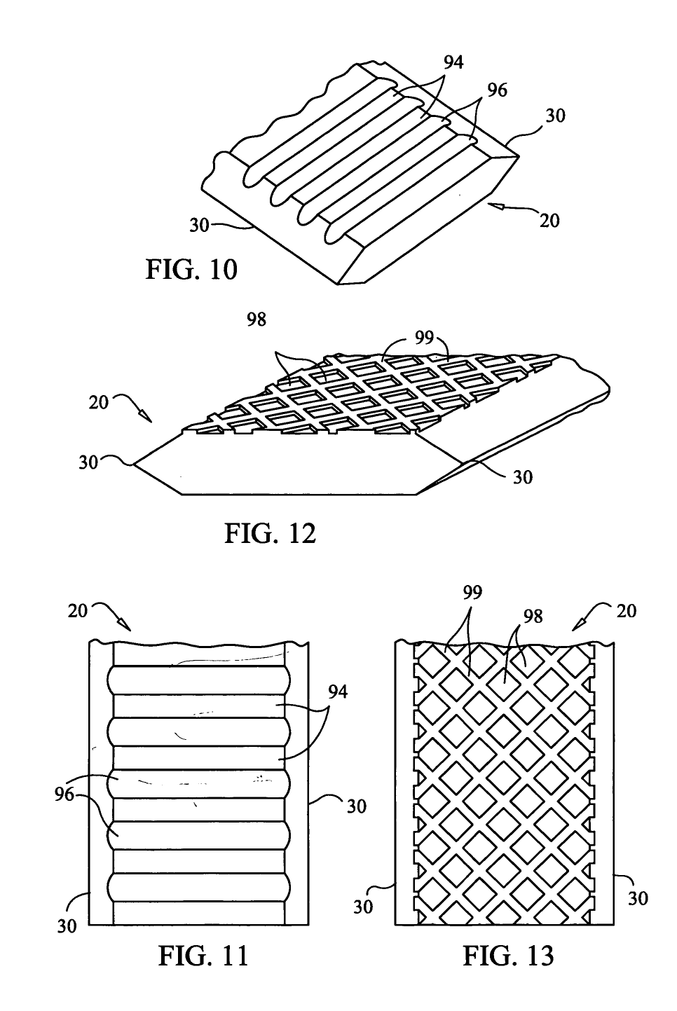

FIG. 10 and 12 illustrate a variation of the line 20, in which the upper planar surfaces 94 (FIG. 19) or 99 (FIG. 12) are interrupted with transverse grooves or channels 96 (FIG. 10) or diamond shaped depressions 98 (FIG. 12). Similar configurations may be formed in the bottom or underside of the lines, the segments of which are shown in FIGS. 10 and 12. FIGS. 11 and 13 are top views, respectively, of the line segments shown in FIGS. 10 and 12.

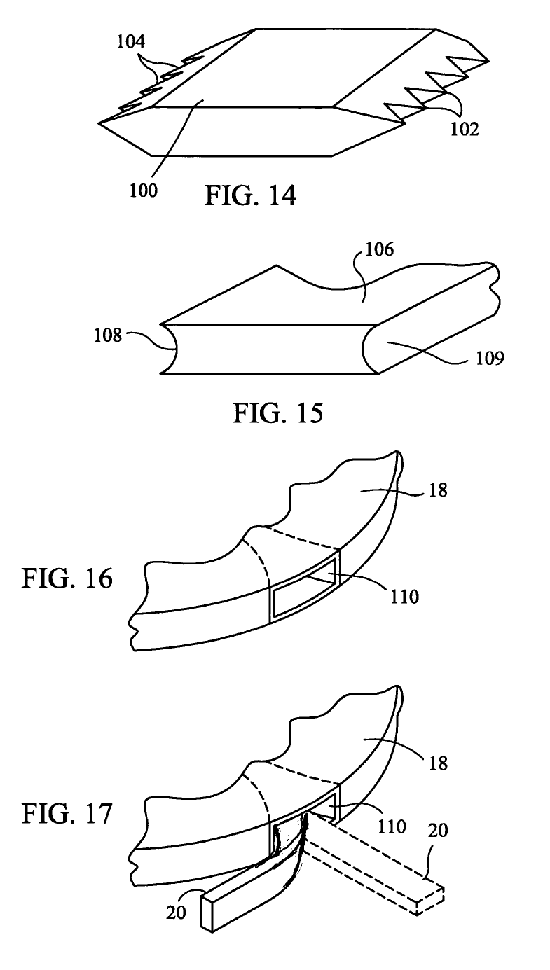

FIG. 14 is another embodiment of a line segment having a flat top surface 100 spaced from a flat parallel bottom surface, with saw-tooth edges 102 and 104 replacing the edges 30, for example, of the embodiment shown in FIG. 4. FIG. 15 is another embodiment illustrating a line segment having an upper flat surface 106 spaced from an unnumbered bottom surface in a parallel plane, with concave edges 108 and 109 replacing the edges 30 or 31 of FIG. 4, for example.

It should be noted in conjunction with the above description of the various embodiments of the invention that the patterns or grooves which have been illustrated in various ones of the embodiments may be formed on both the upper and lower surfaces of the line filaments; or the various grooves, depressions and patterns may be formed on one or the other of the upper and lower surfaces of the line filament, with the opposite surface either remaining flat or having a different pattern on it. It also should be noted that the aspect ratios of the thickness to width of the various line segments may be selected to vary from 1.25 to 8.0, with thicknesses of the various line filament embodiments ranging from about 0.050″ to 0.170″ for current standard machine designs and horsepower. Obviously, these thicknesses and aspect ratios may be adjusted in accordance with the demands of a particular application and the power requirements of the machines. The plastic materials which are used in conjunction with the manufacture of the various line filaments are selected to have a Young's Modulus (stiffness) ranging from eighty thousand to five hundred thousand PSI; and the line extensions from the head exits are chosen to be standard, ranging from approximately 2″ to 8″ depending upon the head design. The head diameters of commercially available machines, with which the line segments discussed above may be used, typically vary between 4″ and 5.2″.

FIG. 16 is a perspective representation of a detail of a portion of a trimmer head 18 showing an exit opening 110 having a vertical height which i s approximately one-fourth the width of the opening. This configuration is made to accommodate line 20 which may have any of the cross-sectional configurations which have been described above. FIG. 17 illustrates the same portion of the head 18 showing the configuration, in dotted lines, assumed by a line segment 20 extending from the opening 110 during operation of the head 18. When a line 20 having the general shape illustrated in FIG. 17, or any of the configurations illustrated in others of the various embodiments, strikes an object, the leading edge rotates either upwardly or downwardly, as illustrated in solid lines in FIG. 17 (showing this edge rotating upwardly) to allow the line to bend as illustrated in FIG. 17, or with less damage than if the line were rigid and unable to bend through the rotating, twisting action which has been illustrated.

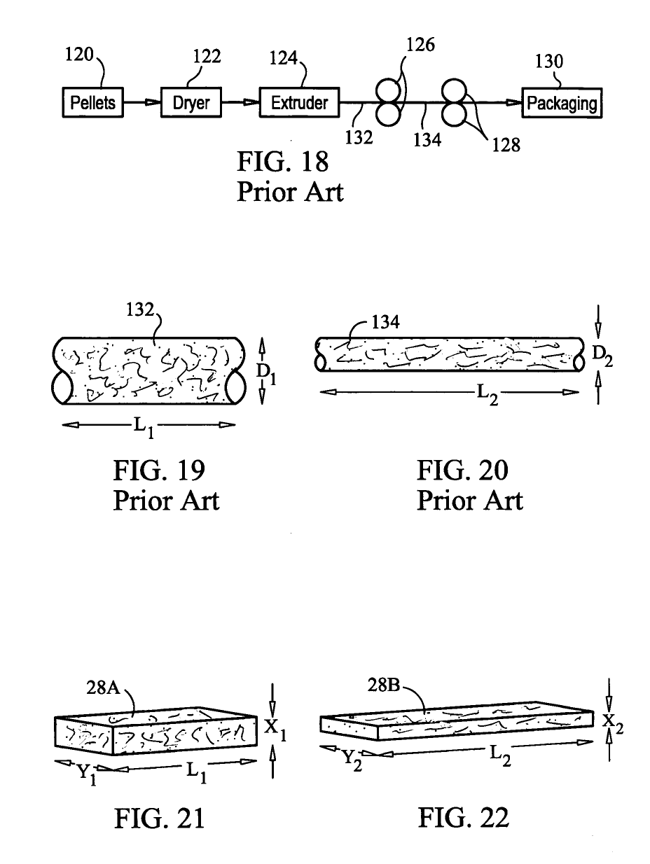

String trimmer line typically is made of high molecular weight extruded plastic materials, as the nylon mentioned above. FIG. 18 illustrates diagrammatically the prior art manner in which monofilament string trimmer line typically is formed. Plastic pellets 120 are dried in a dryer 122, and then supplied to an extruder 124, which produces line at 132 having an initial diameter. The line at 132 then is supplied through one or more sets of pull rolls 126 and 128, shown by way of example, to impart a stretching or pulling on the extruded form of the line in order to enhance the properties of the line and to reduce the diameter to the desired size. The stretching orients the molecules of the plastic in the axial or longitudinal direction; and the degree of stretch or orientation typically is expressed as a factor, such as 3.0× or 4.5× or 6.2×. Generally, the stretch ratio is chosen to give a balance of characteristics desired, such as tensile strength, impact strength, splitting tendency, knot strength, etc. For string trimmer line, the amount of stretching may be different from what is produced for fish line, sewing thread, industrial weaving material, plastic strapping, furniture webbing, film, or the like. All of these factors relate to the relationship of the final length of the article as compared to its original length as it leaves the extruder 132. Once the line, however, has been stretched by means of the pull rolls 126 and 128, it is supplied to a reel or cut-to-length packaging station 130.

By way of example, if a round, unoriented monofilament line segment of 0.260″ and 1″ long, obtained at 132 from the extruder 124 is stretched by 4.0×, the “longitudinally oriented” line theoretically has a length of 4″ and a diameter of approximately 0.130″. The orientation is moderate; and it is generally along the axis or longitudinal direction of the stretch. This is diagrammatically represented in FIGS. 19 and 20 showing the relatively large diameter line 132 having a diameter D1 a length L1, obtained from the extruder 124, with the elongated or stretched line at 134 illustrated as having a diameter D2 (which is less than the diameter D1) and length L2 (which is greater than the length L1) for the same mass or segment of line provided at 132 in the prior art system shown in FIG. 18.

The technique shown in FIGS. 18,19 and 20 is typically employed to form string trimmer line used in both electric and gas powered vegetation trimmers. The longitudinal orientation of the line provides increased tensile strength for the line, but it also results in increased tendency for splitting, with the splitting taking place in the axial direction of the line. A compromise with such splitting tendencies generally is made, however, because of the increased tensile strength, obtained by orienting the high molecular weight molecules in the axial or longitudinal direction.

FIGS. 21,22,23 and 24 illustrate a method which may be employed to produce the line 20 of the various embodiments described above, primarily in conjunction with FIGS. 3 through 15, to form line or line segments having the above described height-to-width aspect ratios and which has a bi-axial orientation resulting in improved operating characteristics.

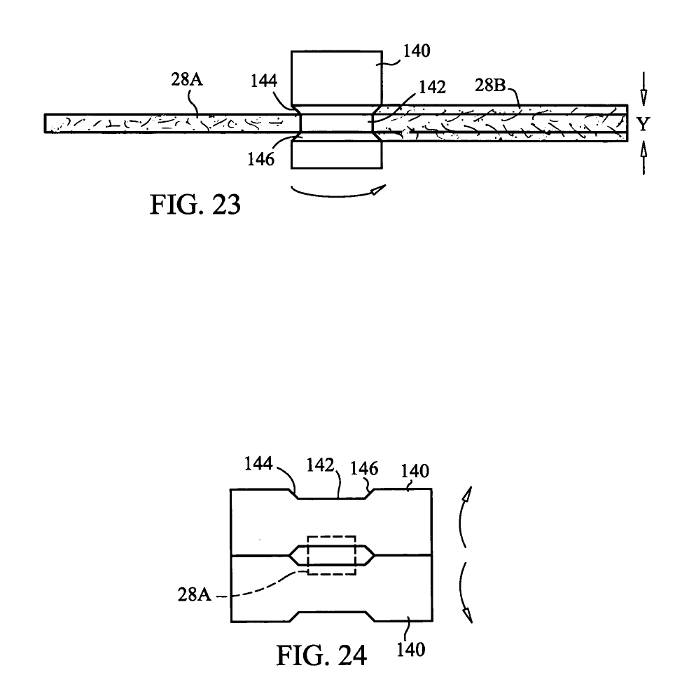

A continuous extrusion, or a fixed length block of unoriented or partially oriented plastic starter material 28A is employed. As illustrated in FIG. 21, the material has a thickness X₁, a length L, a width Y₁. This material, as indicated above, may be obtained from an extruder or may be a cut length of plastic where it is fed, as shown in FIGS. 23 and 24, to a pair of opposing calender rollers 140 having a recessed area 142 in the center thereof, and sloped sides 144 and 146, as shown clearly in FIGS. 23 and 24. As the starter blank 28A is supplied to the space between the rollers 140, the rollers cause an elongation of the starter material and a stretching transversely to increase the width, as illustrated most clearly in FIG. 23. This produces a finished product 28B having a thickness X₂, a length L₂, a width Y₂, the molecules of which are oriented both in the longitudinal (L) direction and transversely in the Y direction because of the pulling or squeezing of the molecules in both of these directions. The orientation may be considered to be bi-axial (length and width), thereby improving strength of the line and reducing the tendency of the ends to split or fray, since the molecules tend to orient angularly outwardly from the center or axis of the final product.

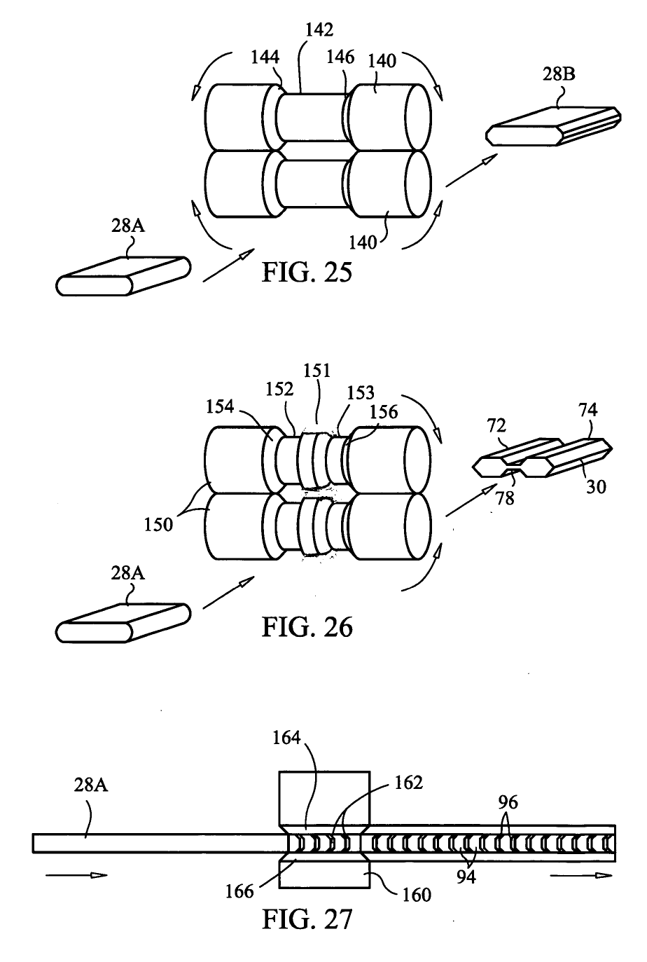

FIG. 25 is a diagrammatic representation of the operation which is illustrated in FIG. 23 to produce a line having a cross-sectional configuration of the type shown in FIG. 4 and described previously. FIG. 26 illustrates a pair of calendering rollers 150 having two recessed regions 152 and 153 spaced apart by a center region which is provided by segments 151, with sloped edges 154 and 156. This arrangement produces a bi-axially oriented line of the configuration shown in FIG. 8.

FIG. 27 illustrates another variation using calendering rollers 160 having transverse raised (or recessed) portions 162 between a pair of shoulders 164 to produce a finished line having an upper flat surface 94 with the transverse sections 96 extending across it, as described previously in conjunction with the embodiment of lines shown in FIGS. 10 and 11.

The foregoing description of the embodiments of the invention is to be considered as illustrative and not as limiting. Various changes and modifications will occur to those skilled in the art for performing substantially the same function, in substantially the same way, to achieve substantially the same results, without departing from the true scope of the invention as defined in the appended claims.

1. A string trimmer line including:
an elongated filament member having a cross section throughout the length thereof with a thickness which is less than the width thereof and which has top and bottom surfaces located in first and second parallel planes, and a portion of at least one of the top and bottom surfaces located in a plane other than the first and second planes.

2. A string trimmer line according to claim 1 wherein parallel transverse cross sections of the elongated filament member are the same throughout the length of the elongated filament member.

3. A string trimmer line according to claim 2 wherein the elongated filament member is made of a high molecular weight orientable plastic.

4. A string trimmer line according to claim 3 wherein the elongated filament member is made of extruded-plastic material.

5. A string trimmer line according to claim 4 wherein the elongated filament member has at least one groove in at least one of the top and bottom surfaces extending the length of the elongated filament member.

5. A string trimmer line according to claim 5 wherein the elongated filament member has first and second tapered edges extending the length thereof in a plane intermediate the planes of the top and bottom surfaces.

7. A string trimmer line according to claim 5 wherein the thickness of the elongated filament member adjacent a centerline thereof is less than the thickness of the elongated member adjacent the edges thereof.

8. A string trimmer line according to claim 1 wherein the elongated filament member is made of a high molecular weight orientable plastic.

9. A string trimmer line including an elongated filament member made of material having molecular orientation in both the direction of the length thereof and in the direction of the width thereof, resulting in bi-axial molecular orientation of the material, the elongated filament member further having a cross section throughout the length thereof with a thickness which is less than the width thereof and which has top and bottom surfaces, at least a portion of which are located in parallel planes.

10. A string trimmer line according to claim 9 wherein the elongated filament member is made of a high molecular weight orientable plastic.

11. A string trimmer line according to claim 10 wherein the elongated filament member has transverse grooves across the width thereof in at least one of the top and bottom surfaces.

12. A string trimmer line according to claim 11 wherein the elongated filament member has transverse intersecting grooves substantially across the width thereof in at least one of the top and bottom surfaces.

13. A string trimmer line according to claim 1 wherein the elongated filament member is made of extruded plastic material.

14. A string trimmer line according to claim 13 wherein the elongated filament member is made of material having molecular orientation in both the direction of the length thereof and in the direction of the width thereof, resulting in bi-axial molecular orientation of the material.

15. A string trimmer line according to claim 14 wherein the elongated filament member is made of a high molecular weight orientable plastic.

16. A string trimmer line according to claim 1 wherein the thickness of the elongated filament member adjacent a centerline thereof is less than the thickness of the elongated member adjacent the edges thereof.

17. A string trimmer line according to claim 16 wherein the elongated filament member has first and second tapered edges extending the length thereof in a plane intermediate the planes of the top and bottom surfaces.

18. A string trimmer line according to claim 1 wherein the elongated filament member has at least one groove in at least one of the top and bottom surfaces extending the length of the elongated filament member.

19. A string trimmer line according to claim 1 wherein the elongated filament member has transverse grooves across the width thereof in at least one of the top and bottom surfaces.

20. A string trimmer line according to claim 1 wherein the elongated filament member has transverse intersecting grooves substantially across the width thereof in at least one of the top and bottom surfaces.

21. A string trimmer line according to claim 1 wherein the elongated filament member has first and second tapered edges extending the length thereof in a plane intermediate the planes of the top and bottom surfaces.

22. A method for manufacturing string trimmer line from high molecular weight plastics including forming an elongated blank of high molecular weight orientable; passing the blank between a pair of rotating calendering rollers to reduce at least a portion of the thickness of the blank and to increase the width thereof to produce a bi-axially oriented elongated filament.

23. The method according to claim 22 wherein the calendering rollers produce at least one groove extending the length of the elongated filament.

24. The method according to claim 23 wherein forming the blank is effected by extruding.

25. The method according to claim 22 wherein the calendering rollers produce transverse channels across the width of the elongated filament.

26. The method according to claim 22 wherein forming the blank is effected by extruding.

27. The method according to claim 26 wherein the calendering rollers produce transverse channels across the width of the elongated filament.

28. A method for producing string trimmer line including extruding a continuous blank of orientable plastic having a transverse cross section of a predetermined area; supplying the continuous blank to a pair of opposing calendering rollers, the space between which has a cross-sectional area equal to the cross-sectional area of the extruded blank, but with a different cross-sectional configuration to cause bi-axial orientation of finished elongated string trimmer line exiting from the calendering rollers.

29. The method according to claim 28 wherein the cross-sectional space between the opposing calendering rollers taken on a plane passing through the axis of both of the calendering rollers of the pair is configured to widen the cross-sectional configuration of a blank of material supplied thereto and to lessen the thickness thereof.
